(19) United States
(12) Patent Application Publication
(10) Pub. No.: US 2015/0012318 A1
(43) Pub. Date: Jan. 8, 2015

(54) Method and an Arrangement for Provisioning of Services

(71) Applicants: Eric HEDMAN, Espoo (FI); Mika VANSKA, Espoo (FI); Santtu KOIVUMAKI, Espoo (FI); Timo HOTTI, Lohja (FI)

(72) Inventors: Eric HEDMAN, Espoo (FI); Mika VANSKA, Espoo (FI); Santtu KOIVUMAKI, Espoo (FI); Timo HOTTI, Lohja (FI)

(21) Appl. No.: 14/316,381

(22) Filed: Jun. 26, 2014

(30) Foreign Application Priority Data
Jul. 4, 2013 (FI) 20130200

(51) Int. Cl. G06Q 10/06

(52) U.S. Cl. CPC G06Q 10/06311
USPC 705/7.13

(57) ABSTRACT

The invention discloses, inter alia, a computer-implemented method for assigning a service provided by a service provider to a document and to a stakeholder in a computer executable service platform comprising a content analysis service, an identity evaluation service, and a service allocation service, wherein the document has a sender, a receiver and content interpretable as structured content. The invention is characterized in that the method contains the step for the identity evaluation service evaluating at least one attribute regarding the identity of a stakeholder of the document having a role of a sender or a receiver, a user having access to the document. The method also comprises the step for the content analysis service resolving at least one attribute value from the content or meta-data of the document. Finally, the method comprises the step of the service allocation service assigning at least one service to the document based on a match between the requirements of the service and the results of the execution of the identity evaluation service and/or the results of the execution of the content analysis service.

### BACKGROUND

This invention is related to provisioning of application services of a multitenant service execution platform. The services may be any application services, including but not being limited to electronic commerce systems, e.g. electronic invoicing, purchase ordering and contract lifecycle management. The multitenant platform may be dealing with business transactions, e.g. invoices and purchaser orders, where each transaction has a plurality of stakeholding parties, e.g. a sender and a receiver of a business transaction, e.g. an invoice. Each of the stakeholders may be associated with a plurality of users, e.g. employees of the company who is the stakeholder of the transaction.

The service execution platform may host a potentially large number of services that can be made available to those transactions and stakeholders who meet the criteria of the service. Preferably, from the large number of services, those services should be promoted to the stakeholders that are easy to activate for the stakeholder and that are of value for the stakeholder.

In known systems, there typically exists an administrative function in the service execution platform that comprises the means for the provisioning and configuration work based on a service subscription done by a stakeholder. In such systems, the service subscribers must know, which services they want to use and what actions need to be taken in order to activate the service. For example, if there are multiple different services available for approximately the same purpose, finding the most easily accessible and useful service for the exact needs of the subscriber may become difficult. Furthermore, it is often difficult to estimate the effort that is required to provision the service for the subscriber and especially, to make the data of the subscriber eligible for the service.

It is also well known in the art that there are configuration services available, e.g. data capturing services, format conversion services or identity verification services that may be used to make stakeholders and data eligible for an application service.

The known solutions have some unanswered issues, especially in a system that has a large number of services available for some data and for the stakeholders of the data. Different services have different requirements for the transaction data and the properties of the stakeholder. Some are easier for the stakeholder to comply with than other. On the other hand, some services are more valuable to the stakeholder than other. Optimally, the services that are the most valuable for the stakeholder and may be made accessible to the stakeholder with least effort from the stakeholder, should be offered and eventually provisioned for the stakeholder. On the other hand, it would be beneficial for the platform operator to have as useful and trustworthy information about the users, organizations and their relationships (i.e. business network data) as possible. A solution that guides and encourages the stakeholders to establish and maintain valid, high-quality information is thus desired.

An object of the invention is to provide a method, an arrangement and/or a computer software product stored in a computer readable medium for guiding the stakeholders of the business transaction data of a multitenant service execution platform to using services that are of value to the stakeholder and/or that are easily provisioned for the stakeholder.

### BRIEF DESCRIPTION OF THE INVENTION

An aspect of the invention is a computer executable method for assigning a service provided by a service provider to a document and to a stakeholder in a computer executable service platform comprising a content analysis service, an identity evaluation service, and a service allocation service wherein the document has a sender, a receiver and content interpretable as structured content and optionally meta-data. The method may be characterized in that it comprises the step for the identity evaluation service evaluating at least one attribute regarding the identity of the stakeholder of the document having the role of a sender or a receiver, or a user representing the stakeholder and having access to the document. The method may also comprise the step of the content analysis service resolving at least one attribute value from the content or meta-data of the document. Finally, the method may also comprise the step of the service allocation service assigning at least one service to the document and/or stakeholder based on a match between the requirements of the service and the results of the execution of the identity evaluation service and/or the results of the execution of the content analysis service.

The method may also comprise the step of calculating and storing information comprising estimate of the utility of the service to the stakeholder, e.g. via analysis of usage of the service by organizations having similarities with the evaluated stakeholder.

The method may also comprise the step for storing information comprising estimation about an effort required to remedy a deficiency in at least one of the following: an attribute of the document, an attribute of the stakeholder and an attribute of a user related to the stakeholder.

The method may further comprise the content analysis service identifying at least one attribute whose value is missing from the document required to use the service. The service allocation service may be adapted to prepare a computer executable instruction adapted to remedy the missing attribute value of the document.

The method may further comprise the identity analysis service identifying at least one attribute of the stakeholder or user that has a missing or insufficient value to use the service. The service allocation service may be adapted to prepare a computer executable instruction adapted to remedy the missing or insufficient attribute value of the stakeholder or user.

Another aspect of the present invention is an arrangement or system comprising at least one server computer. The arrangement or system is adapted to comprise computer executable means for performing the steps of a of method disclosed herein.

Yet another aspect of the present invention is a computer program product stored on a tangible computer readable storage medium. The product is adapted to comprise computer executable instructions for the purpose of performing a combination of steps of a method disclosed herein.

### DRAWINGS

Some preferred embodiments of the invention are described below with references to accompanied figures, where:

FIG. 1a depicts an exemplary arrangement of software processes according to a preferred embodiment of the present invention,

FIG. 1b depicts an exemplary diagram of entities usable in an embodiment of the present invention,

FIGS. 2a-c depict relationships and management of some entities of a preferred embodiment,

FIGS. 3a-c depict, using flow diagrams, some aspects of the method of an embodiment of the present invention,

FIG. 4 illustrates some example data usable by an embodiment of the present invention,

FIG. 5 illustrates an example about associating services with a document and its stakeholders and users according to an embodiment of the present invention, and

FIG. 6 shows a schematic diagram of a computer usable in an embodiment of the present invention.

### DETAILED DESCRIPTION OF PREFERRED EMBODIMENTS

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing information in a form readable by a machine (e.g., a computer). For example, a machine-readable medium includes read only memory (“ROM”); random access memory (“RAM”); magnetic disk storage media; optical storage media; flash memory devices; etc.

Some embodiments of the present disclosure may include one or application programming interfaces in an environment with user interface software interacting with a software application. Various function calls or messages are transferred via the application programming interfaces between the user interface software and software applications. Transferring the function calls or messages may include issuing, initiating, invoking or receiving the function calls or messages. Example application programming interfaces transfer function calls to implement scrolling, gesturing, and animating operations for a device having a display region. An API may also implement functions having parameters, variables, or pointers. An API may receive parameters as disclosed or other combinations of parameters. In addition to the APIs disclosed, other APIs individually or in combination can perform similar functionality as the disclosed APIs.

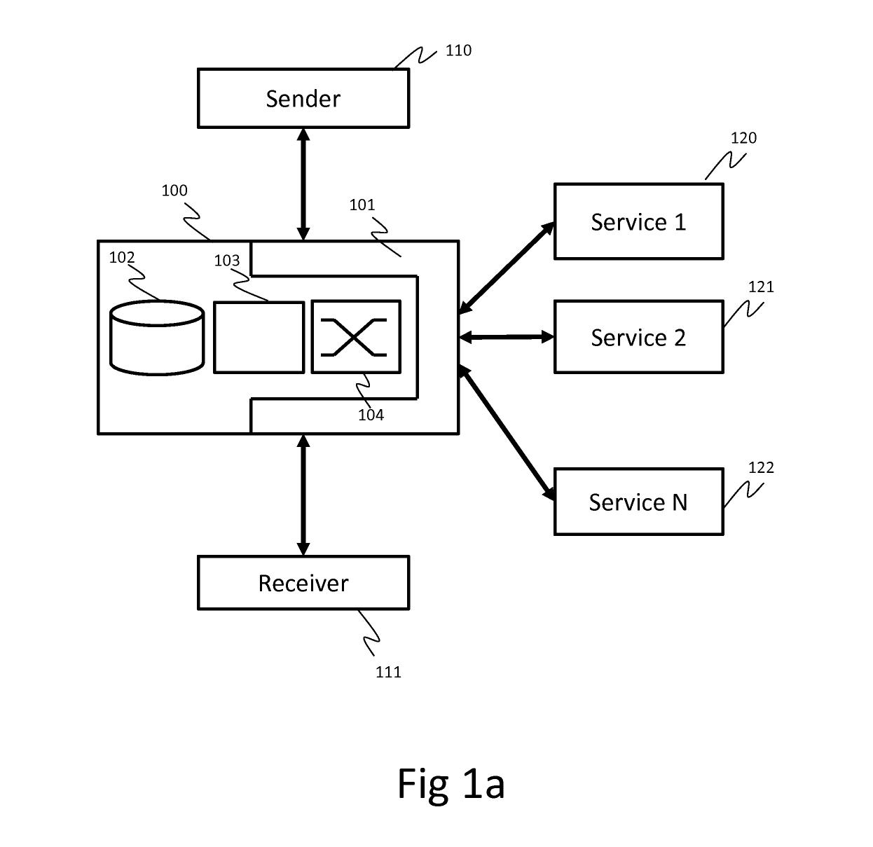

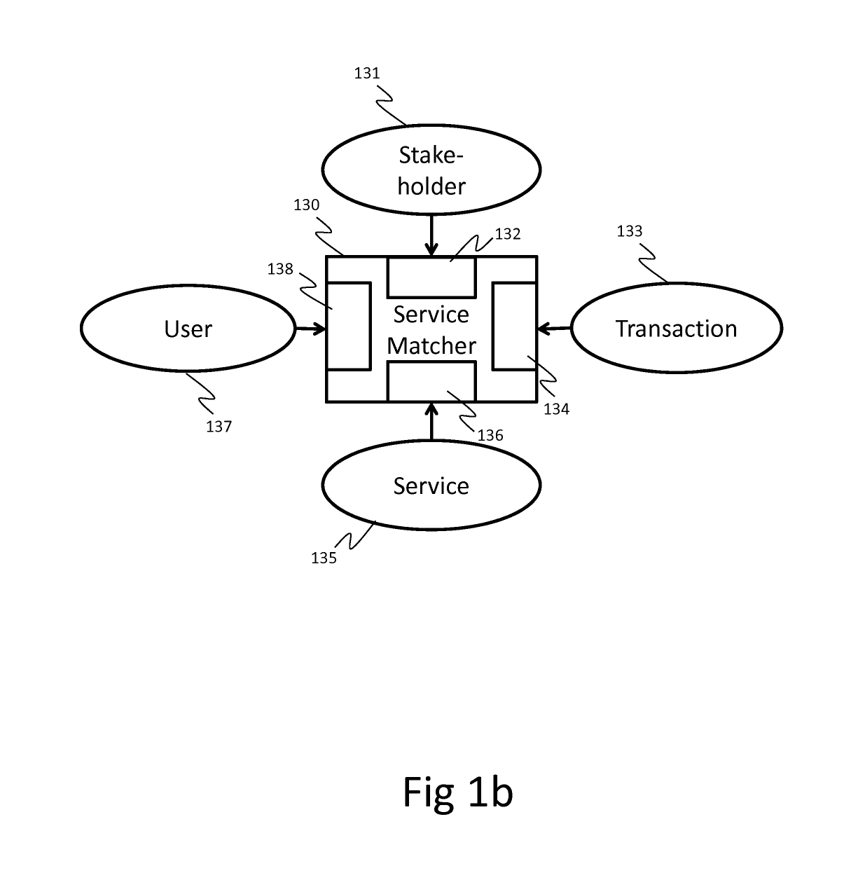

FIG. 1a depicts an arrangement of software processes according to a preferred embodiment of the present invention.

The application service execution platform 100 is a software process executable by at least one computer processor using data residing in the memory of at least one computer.

The platform 100 comprises a data communication interface 101 for the purpose of transmitting data to and from other software processes, such as process 110 sending transactions, e.g. invoices and process 111 receiving transactions. The platform is also communicatively connected via the interface 101 to software processes 120, 121, 122, that provide services, e.g. invoice financing services or collaboration services, related to the transactions. The processes 110 and 111 represent so called primary stakeholders of a transaction and the processes 120-122 represent so called secondary stakeholders (e.g. parties that have access to transaction data owned by a primary stakeholder in order to provide a service on the data) of a transaction. The concepts of the primary and secondary stakeholders are further discussed later in this chapter.

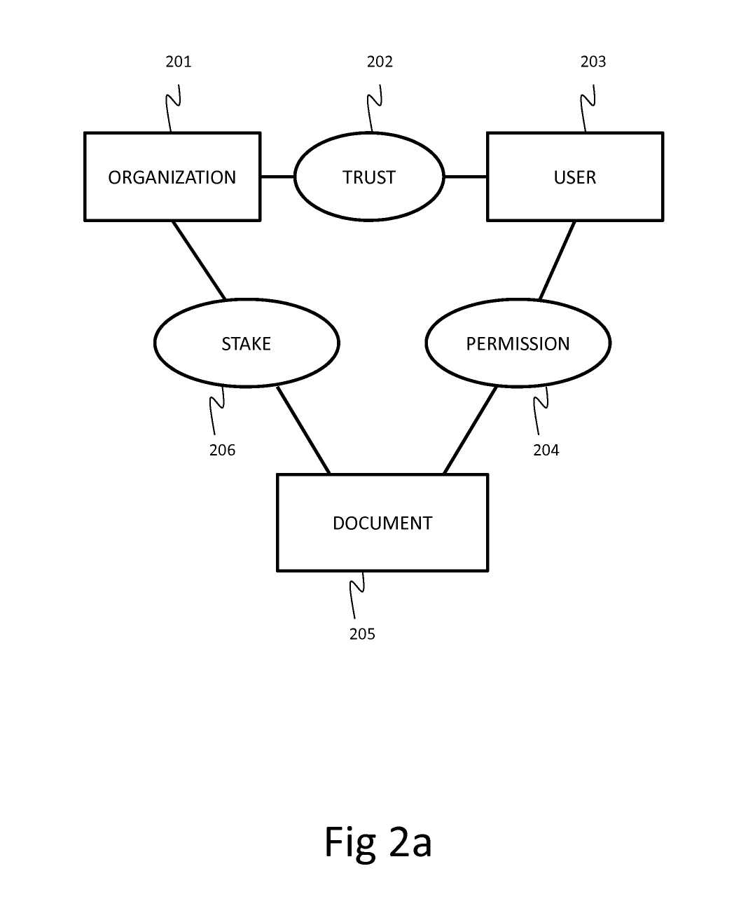

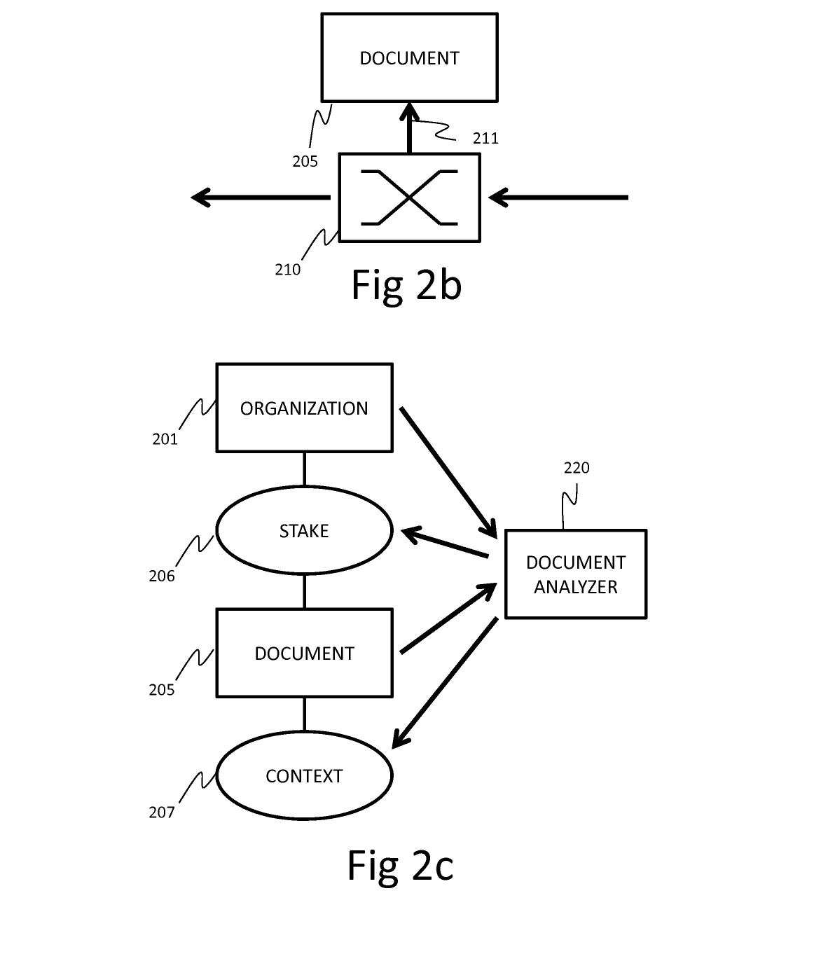

The platform 100 further comprises a data management component 102 that manages the data needed by the application logic 103 of the platform. The application logic comprises service matching logic explained later in FIG. 1b. An exemplary description of the data managed by the data management component is provided in the FIG. 2a of this detailed description. The platform further comprises a transaction routing module that analyses incoming transactions and determines their destination(s). In a preferred embodiment, an incoming business transaction, e.g. an invoice, is routed to its intended recipient 111 and possibly to at least one, preferably a plurality of service providers 120, 121, 122.

The software processes of the FIG. 1a may be arranged to be run in a single computer or they may be run in a system comprising a plurality of computers that are communicatively connected with each other using e.g. network communication interfaces.

FIG. 1b depicts the service matching component 130 of an embodiment of the present invention. The service matcher 130 reads characterization information 136 about a service 135. In a preferred embodiment, the characterization information 136 comprises requirement data about users 137, stakeholders 131 and/or transactions 133 that may be used by the service. The service matcher further reads characterization data 138 of at least one user 137, characterization data 132 of at least one stakeholder 131 and/or characterization data 134 of at least one transaction 133.

In an embodiment, the characterization data (138, 132, 134) of the respective data object (137, 131, 133) comprises meta-data associable with the data object.

The characterization data 138 of a user 137 may comprise e.g. indication of the trustworthiness of the identity of the user. The trustworthiness may for example have three different values (e.g. “untrusted”, “limited trust”, “trusted”) based on what kind of activities the user, or some other user associable with the user, has performed in the system to increase his/her trustworthiness. A service 135 may require, that a user who has access to the service meets certain criteria regarding the characterization data 138, e.g. has a certain degree of trustworthiness in the system. If the criteria are not met, the service matcher may prepare some computer-executable instruction e.g. to suggest some action that remedies the deficiency. The computer executable action may be implemented e.g. as a call to a service, e.g. a web service. For example, the trustworthiness of a user may be improved by having the user to authenticate himself/herself using some web-based identity management service that is capable of guaranteeing the identity of the user.

The characterization data 132 of a stakeholder 131 may comprise e.g. company profile data such as area of business, size of the company, number of connections to other companies in a business network, trustworthiness of the (source of the) company data etc. A service 135 may require, that a stakeholder, who wishes to subscribe to the service, must meet certain criteria, e.g. the stakeholder may need to have some confirmed business relationships in the network. If the criteria are not met, the service matcher 130 may prepare some computer executable instruction, e.g. for a user 137 representing the stakeholder 131 to remedy the deficiency. For example, the service matcher may suggest, that some user 137 is assigned as an official representative of the stakeholder 131 in the network using a procedure implemented as a computer executable service.

The characterization data 134 of a transaction 133, e.g. an invoice or a purchase order, may comprise e.g. content and/or meta-data captured from a document comprising the transaction data. For example, an invoice typically has sender and recipient information, invoice line item data, tax data, due date and total amount data. The service requirement data 136 of a service may specify, that certain data attributes, e.g. total amount and due date of an invoice, must be captured from the document in order for the transaction of the document to be eligible for the service. Should some attributes be missing, the service matcher 130 may prepare a computer executable action to be executed by a user representing a stakeholder of the document to remedy the deficiency. The action may e.g. be a call to a data capture service that the user may use to teach the capture of the missing data from the transaction (and from subsequent similar transactions).

In a preferred embodiment, the user effort and/or cost of executing a computer executable action to remedy a deficiency is assigned to the action. On the other hand, the value of a service to a stakeholder is estimated and assigned to the service. The most relevant services to the stakeholder are those whose value/effort ratio is the best of the available services. The service matcher 130 thus advantageously comprises means for calculating the value/effort ratio for a plurality of services 135 for the transactions 133 and users 137 of a plurality of stakeholders 131 and for sorting the services e.g. for each stakeholder 131 in the order of the calculated ratio. On one hand, this value estimator makes it possible to identify services that are most valuable to a particular organization (stakeholder). On the other hand, the value estimator guides the developers of the services to develop such services that are easy to provision for their target customers.

FIG. 2a depicts an exemplary overview of the data objects managed by the data management component of the server (102 in FIG. 1a) of an embodiment of the present invention. The master data comprises three main entities (objects): organization data 201, user data 203 and document (transaction) data 205. Each organization may act as a stakeholder 206 of a business document 205. For example, an organization 201 may be a seller or a buyer of an invoice. An organization may be represented by at least one, preferably by a plurality of users 203 through a trust relationship 202. The trust relationship 202 may specify a context, e.g. a service class comprising a plurality of services, in which the user 203 may represent the organization 201. The representation may occur e.g. via a service that is associated with the context. For example, an organization may trust a user to represent the organization in all invoicing related contexts or in a specific invoicing related context, e.g. collaboration processes between organizations that aim towards a dispute resolution. The available contexts may be defined and maintained in the access control services of the data management service 102 running on computer 100. A context may be associated with any number of services and a service may be associated with multiple different contexts. For example, there may be multiple different services for the context of dispute resolution of invoices. The services may be provided by different service providers.

In the embodiment shown, the user 203 is further linked to at least one document 205 via an access permission link (object) 204. The permission 204 may specify which kind of access the user has to the document. The access permission may be e.g. for a read access or for a read/write access. The permission may also contain information about the basis of the permission. One basis for a user to have access to a document may for example be that the same user has access rights to the document or has accessed the document in another system, e.g. a sender system 110 or a receiver system 111.

Another basis for a user to have access to a document may be that another user, with whom the user has a trust relationship in a context, is allowed to access or has accessed the document in the context of the trust. A permission object 204 may thus be created between a user and a document when another user has accessed or has permission to access the document utilizing trust of the user. Yet another basis for user to have access permission to a document may be e.g. a rule that has been defined in the established trust relationship. For example, the rule may specify that the user, to whom the trust has been granted, has access permission to the same documents to which the grantor of the trust has access permission. Yet another basis for a user to have access to a document is that the user has been associated with a contact point to which the master data management system has assigned the document using e.g. some suitable document routing logic.

The data objects mentioned herein may be implemented and stored in the memory of a computer e.g. as data objects or in any other manner accessible and modifiable by a processor of the computer. The functional components of various embodiments described herein, including steps of various methods, may be implemented as instructions executable in the memory of a computer by the processor of the computer.

In an embodiment, the data model of FIG. 2a is used for user 203 access authorization purposes in a multitenant system comprising a plurality of organizations 201 and a plurality of documents 205, each document having at least one, preferably multiple, organizations as stakeholders. If a user 203 wants to represent an organization in a process (context of a service) involving a document, the user 203 needs to have established a trust link (relationship) 202 with the organization 201 either directly or via another user 203 who already has established a trust relationship 202 with the organization. Additionally, the user needs to have a permission link 204 to the document 205 and the organization 201 must be a stakeholder 206 of the document 205.

FIG. 2b depicts an exemplary arrangement for importing document data (transactions) into document collection 205 of the storage 102 of server 100 e.g. via a data exchange interface 211. The arrangement comprises a source of documents 210, for example a document router or an application service adapted to receive a document for storing it in the data management component 102 of the system 100. Copies of the documents are transmitted from the source of documents to the collection of documents 205 using the data exchange interface 211. The document source may also transmit supplementary data associable with the business documents.

Such data may comprise e.g. meta-data, access control information, event information or state change information related to the business document.

The documents imported to the document collection 205 are analyzed using for example the arrangement shown in FIG. 2c. The analysis is needed to establish the stakeholder relationships 206 between organizations 201 and imported documents 205. The analysis is performed using a document analyzer component 220. The analyzer inspects the data of the imported document and determines based on its findings, which organizations are stakeholders of the document. The inspected data may comprise captured content of the document and/or meta-data related to the document. The content (attributes) of the document (transaction) may contain e.g. the name and address information of the sender (seller) and recipient (buyer) of an invoice. In an embodiment, a specific combination of information may identify two stakeholders. E.g. the seller name specifies the seller but the associated address or other contact information specifies the finance company which performs the invoicing on behalf of the seller. In such case, both the seller and the finance company should be added as stakeholders of the document. The meta-data of the document may comprise e.g. routing information of the document in a document routing network or some data related to an activity performed on the document. In addition to establishing the stakeholder relationships 206 between organizations 201 and documents 205, the document analysis process performed e.g. by the document analyzer component 220 determines the possible contexts 207 of the document 205. The contexts may e.g. indicate, which (kind of) services may be provided for the document. The process of determining the possible contexts may utilize e.g. the content of the document 205 or any properties of the stakeholder organizations 201 as input. For example, a context may require a certain property (attribute) from the document, a certain capability from the application services of the sender and/or a certain capability from application services of the receiver. To exemplify further, in order to be able to provide a factoring service to an invoice, the invoice may need to contain a discount percentage for quick payment of the invoice and the receiver of the invoice must be able to receive the invoice from a party other than the original sender. The “factoring” context (and services of that context) can thus be associated with an invoice only, if it contains the discount percentage and the receiver meets the interface criteria set for factoring services.

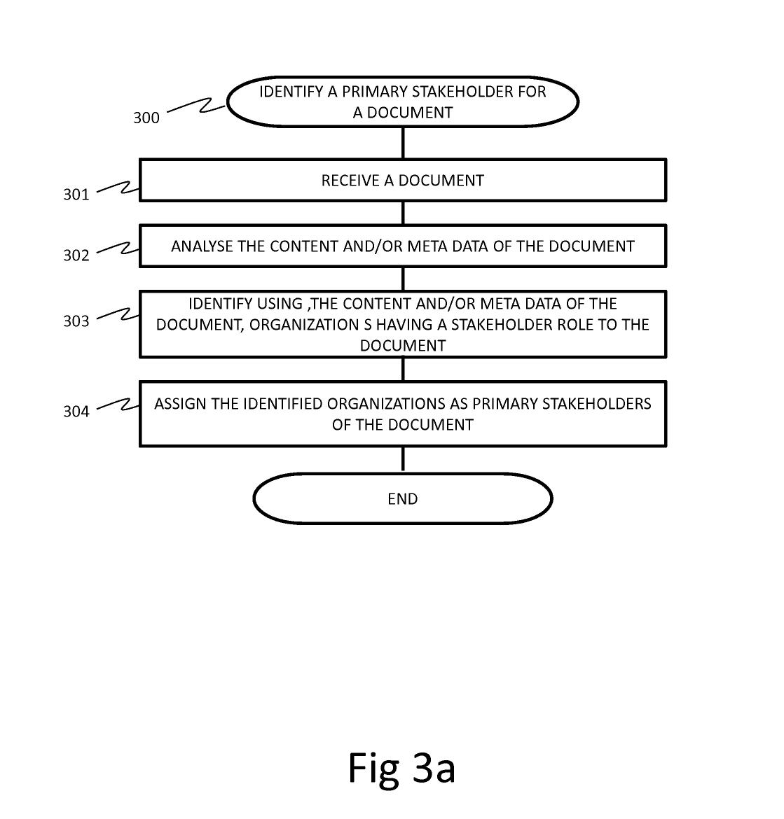

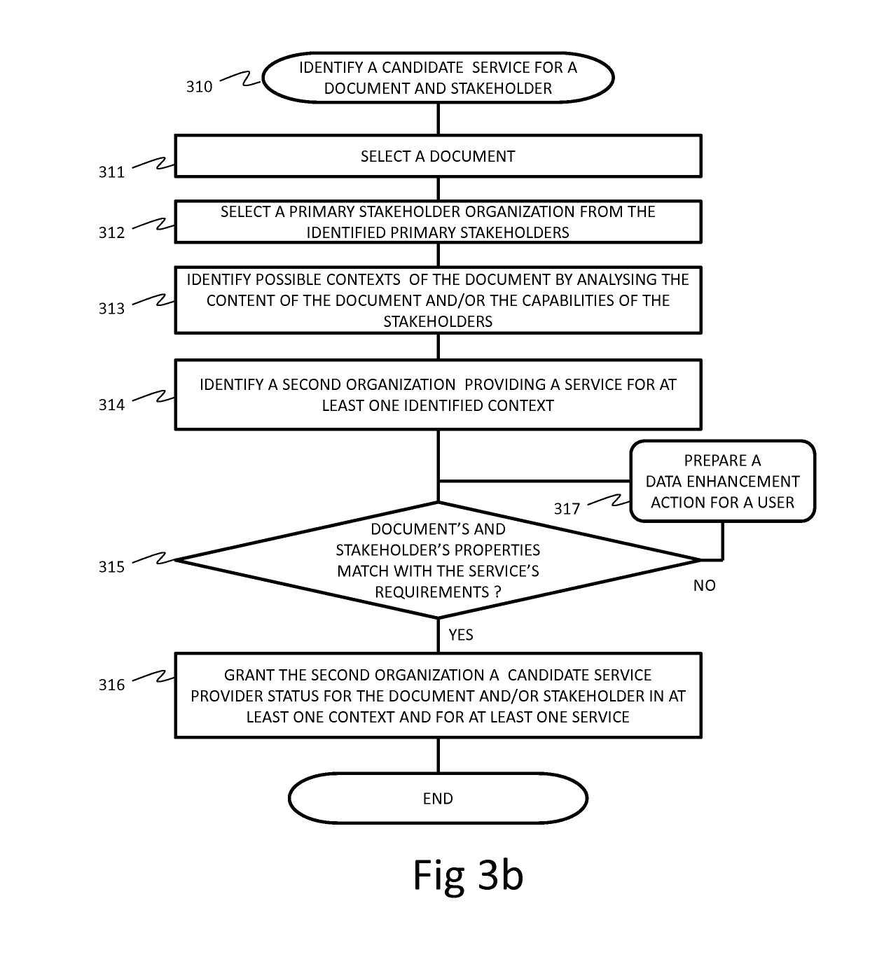

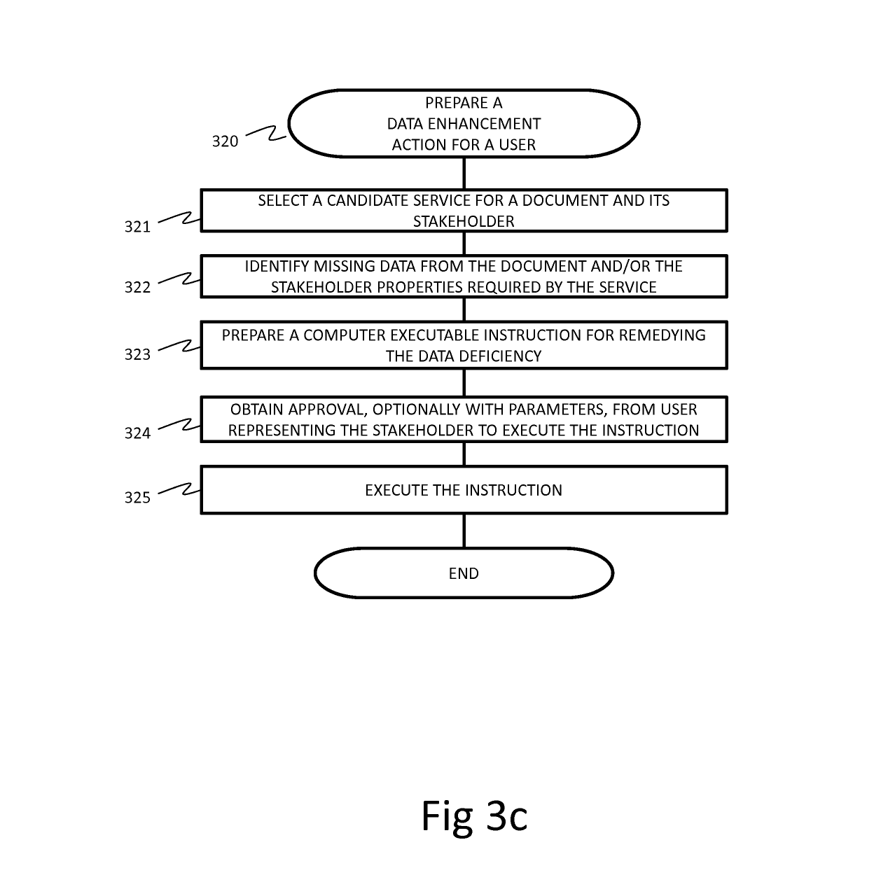

FIG. 3a shows a flow diagram about identifying 300 a primary stakeholder of a document. In step 301, a document is received into the database residing in the storage 102 of the system 100. The document may have any suitable format comprising structured and/or unstructured data. The structured data may be e.g. XML data and the unstructured data may be e.g. document image data. In step 302, the content of the document is analyzed. If the content is in an unstructured format, the content is converted into a structured format so that at least some individual data attributes of the document may be assigned a semantic meaning. Next, in step 303, at least one organization (201 in FIG. 2a) is identified from the content of the document to be a primary stakeholder, e.g. a sender or a receiver of an invoice, of the document. In an embodiment, the primary stakeholder identification process must identify at least two primary stakeholders for the document. Failure to do so marks the document as an erroneous document that requires e.g. manual resolution. In a preferred embodiment, the identified organizations must be available in the organization data collection of the database of the data storage 102. Finally, in step 304, the identified organizations are assigned as primary stakeholders of the document.

In a preferred embodiment, the document may also be assigned with at least one organization that may be capable of providing at least one service (120, 121, 122 in FIG. 1a) related to the document. In a preferred embodiment, such organization may become a secondary stakeholder to the document as a provider of a service. The flow chart of FIG. 3b depicts an exemplary method 310 of identifying such services. In step 311, a document is selected for the process. The document may be e.g. an invoice that was received in the process described in FIG. 3a. Next, in step 312, a previously identified primary stakeholder is selected from the list of primary stakeholders of the document. Next, in step 313, possible contexts of the document are identified. In a preferred embodiment, the identification process inspects the content of the document and/or the characteristics and/or capabilities of the already known stakeholders of the document. For example, a document may belong to an electronic invoice routing context, if the document can be interpreted as an electronic invoice, i.e. it is already one or it can be translated into one, and the receiver of the document, i.e. a primary stakeholder, is capable of receiving electronic invoices. In an embodiment, there may be at least one property that is missing from the document or stakeholder to be eligible for the context, but the property may be obtainable if e.g. a user initiates a suitable computer executable action. In step 314, at least one second organization is identified, who provides a service that belongs to at least one of the identified contexts of the document. Next in step 315, the document's and stakeholder's properties are matched with the requirements of the service. If some properties are missing, a computer executable data enhancement action is prepared 317 for a user representing the stakeholder to execute to remedy the deficiency. An example of a more detailed method for this step is provided in FIG. 3c. If the properties match with the service's requirements, the second organization providing the service is granted the status of a candidate service provider for the document and/or the primary stakeholder 316. The primary stakeholder may now subscribe to the service.

FIG. 3c illustrates a method of preparing 320 a data enhancement action for a user to perform. In step 321, a candidate service for a document and its stakeholder is selected. At least one possible candidate service has been identified in step 314 of FIG. 3b. Next, in step 322, at least one missing data attribute from the document or at least one property of a stakeholder or a user is identified. The missing data attribute or property is something that is required by the selected candidate service.

The missing data attribute of the document may be for example may be an attribute that typically exists in every document of the same type (e.g. “due date” or “total amount” field of an invoice) but that has not been automatically captured from the document. To remedy the deficiency, the application logic of the service matcher 130 identifies a service that the user may invoke. For example, the service may be a data capture service that the user may use to teach the service how to capture the value of the missing data field from the document. The taught capture information may be used later to automatically capture the data from the subsequent similar documents.

The missing property of a stakeholder or a user may be for example trust level of the user identity that is not sufficient for the service provider. The trust level may for example be any of the following: untrusted, limitedly trusted or fully trusted. Untrusted could mean that nobody has confirmed the identity of the user. Limitedly trusted could mean that the identity of a user has been confirmed by another user e.g. directly (e.g. by explicitly endorsing the user) or indirectly (e.g. by performing some business function with the user). Fully trusted could mean, for example, that the user has used some identity management service, e.g. authentication service of a bank, having strong authentication method to confirm his/her identity.

The missing property (attribute) of a stakeholder or a user may also be for example a connection of insufficient strength between the user and the stakeholder. In a preferred embodiment, a user may obtain representation authorization of an organization (stakeholder) in at least one context via a trust relationship established between the user and the organization. The strength of the trust relationship may vary. At its weakest, the representation relationship between the user and the organization may be something that an untrusted user has established him/herself and nobody has confirmed it. At its strongest, the trust relationship between the user and the organization may have been established by an external, trusted authority to a user whose identity is fully trusted and where the external authority guarantees that the user is officially representative of the organization e.g. because he/she is, according to some official document, the CEO or other executive of the organization. Between these ends, there may be intermediate levels of trust. One way to obtain such intermediate level of trust is to have a number of third parties (e.g. vendors to a buyer) confirm that the user is a representative of the organization.

The missing property of a stakeholder or a user may also be for example a connection of insufficient strength between the (primary) stakeholders of the document. Some services, e.g. a financing service, may for example require that the sender and receiver of an invoice truly have a business relationship. This may be needed for example in order to be sure that the invoice is not a fake invoice. Such fact may be verified e.g. from some earlier documents (orders or invoices) and/or actions. The verification of the business relationship may also be obtained explicitly from the recipient of the invoice. The trustworthiness of the explicit verification may depend on the trustworthiness of the identity of the verifying user and/or the trustworthiness of the representation relationship between the verifying user and the recipient stakeholder organization.

The missing property of a stakeholder or a user may also be for example an insufficient number of connections between the stakeholder and other organizations. Some services may require that the stakeholder is sufficiently well networked with other organizations having presence in the service execution platform (100 in FIG. 1a). To remedy such deficiency, the service execution platform may suggest executing a service that imports stakeholder's business contact information into the storage 102 (in FIG. 1a) from some external source, e.g. an ERP (Enterprise Resource Planning) system. For example, a financing service, which is able to set the price of the financing service based on the risk profile of the customer organization, may require that sufficient number of business partners of the customer is known to assess the risk level of the customer.

When the missing data or property has been identified, the application logic 103 of the service execution platform 100 prepares a computer executable instruction for remedying the deficiency in step 323. The instruction may be e.g. a URL (uniform resource locator) to a web-based service or some other service invocation that is sent to a user representing the relevant stakeholder e.g. as an e-mail message or using some other suitable means. Once the user receives the instruction, the user approves executing the instruction e.g. by executing the URL. The user may specify some parameter data as part of the approval. Finally, in step 325 the instruction is executed in the memory of a computer belonging to the service execution platform 100. Now the document data and stakeholder and/or user properties are sufficient for the service selected in step 321 and the service may be presented to the (user representing the) stakeholder as an available service that may be subscribed.

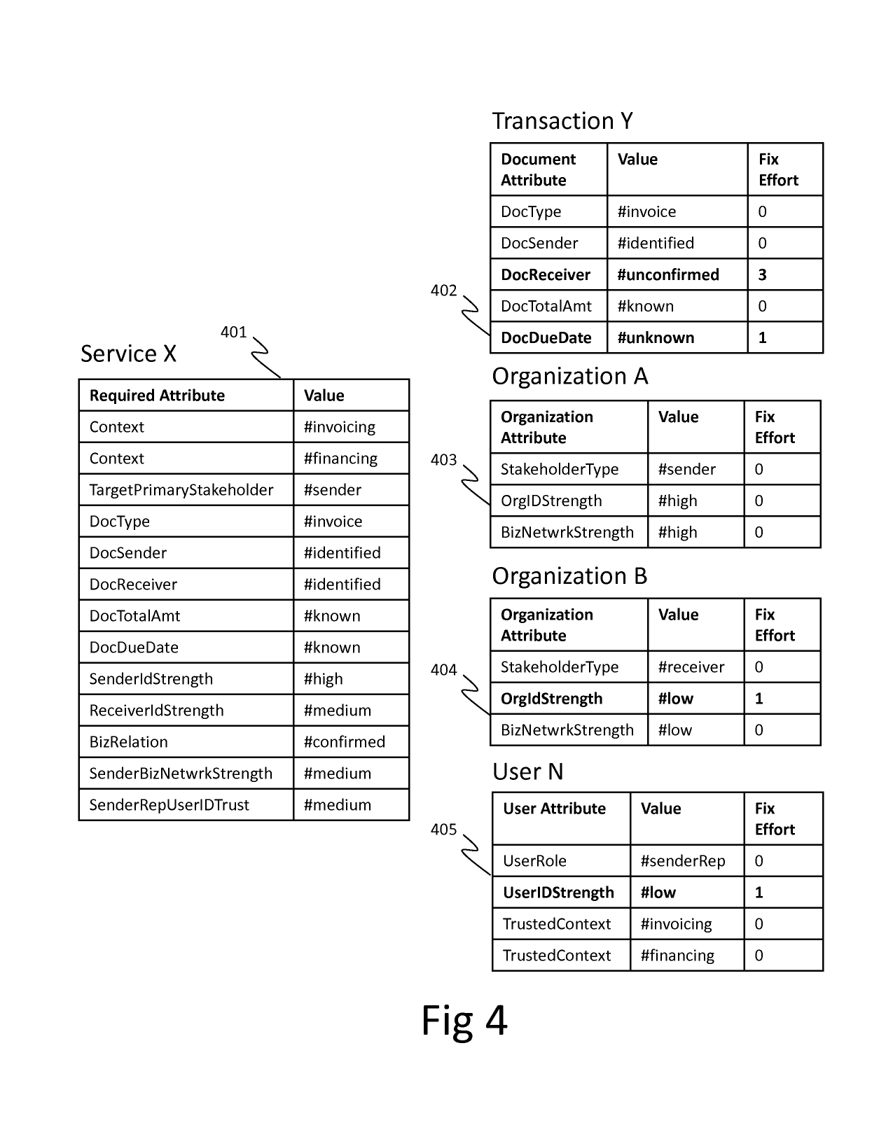

FIG. 4 shows an example about property (attribute) requirements 401 of a service and properties of the related transaction 402, organizations 403, 404 and user 405 according to an embodiment of the present invention. The property requirements of a service 401 comprise a plurality of required attributes and their values. In a preferred embodiment, the possible attribute names and at least some of their possible values are maintained by the service execution platform 100. Thus all services, organizations and users of the platform may utilize the common vocabulary when characterizing service requirements and the properties of transactions, organizations and users.

In the embodiment shown, a service named “Service X” belongs to the service contexts of invoicing (Context=#invoicing) and financing (Context=#financing) and it is targeted for senders of documents (TargetPrimaryStakeholder=#sender). In a preferred embodiment, the context information of the service is defined and maintained by the service execution platform 100. According to the service characterization data of table 401, the service is applicable to invoice-type documents (DocType=#Invoice) where reliable identification information for both the sender and receiver is obtainable from the invoice (DocSender=#identified and DocReceiver=#identified) and where the total amount and the due date of the invoice are known (DocTotalAmt=#known and DocDueDate=#known). The service requires that the sender has been strongly identified (SenderIdStrength=#high). This may mean for example, that the data of the sending organization has been obtained or verified from an official register. The service further requires, that the receiver's identity is of medium strength (ReceiverIdStrength=#medium). This may mean for example, that the identity has not been strongly confirmed from an official register, but a number of organizations have interacted with the receiver organization using the identity of the organization. Yet further, the service of the shown embodiment requires, that there exists a confirmed business relation between the sender and the receiver (BizRelation=#confirmed). For example, there should be at least one prior transaction between the companies that has been approved. The service of the example further requires that the sender's business network strength is at medium level (SenderBizNetwrkStrength=#medium). This may for example mean, that there are at least a certain number of organizations in the business network of the sender. Finally, the service requires that the trust on the identity of the user representing the sender organization is at least at medium level (SenderRepUserIdTrust=#medium), e.g. there exist at least a certain number of other users, who interact with the user using the identity information of the user.

In an embodiment, the utility of the service for a target organization (e.g. sender or receiver of an invoice) and/or user is estimated. The estimating process may be executable by a computer of the system (100 in FIG. 1). The process may utilize e.g. historical information about the usage of the service. For example, the more other similar organizations actively use the service, the higher its utility may be for the target organization. The estimating process may also analyze the effect of using the service in a peer organization. For example, if a peer organization is, with the help of the service, able to receive payments to invoices on average 30% faster, the utility of the service for the target organization may be estimated to be high. In the example shown, the utility of the service to the target organization (e.g. the sender of the invoice) is estimated to have value 10.

According to a preferred embodiment of the present invention, the properties of the transactions, participating organizations and users must match with the requirements of the service. Table 402 shows the exemplary properties of a transaction (“Transaction Y”). According to the properties, the type of the document is “#invoice”, the sender of the document is identified by the system (DocSender=#identified) and the total amount of the invoice is known (DocTotalAmt=#known). However, the Transaction Y in its current state does not conform with the requirements of the Service X, as the receiver of the document is not reliably identified by the system (DocReceiver=#unconfirmed) and the due date information of the document has not been captured from the document (DocDueDate=#unknown). The “fix effort” column of the table 402 shows the estimate about amount of effort required to fix the deficiencies. In the shown example, having the receiver of the invoice reliably identified by the system (e.g. 100 in FIG. 1) is estimated to require effort of 3 and having the due date information captured from the document is estimated to require effort of 1. The units of the fix effort estimates may be selected in any convenient manner, e.g. as amount of time of manual work required.

Table 403 shows the properties of “Organization A” in relation to the “Service X”. The organization is the sender (StakeholderType=#sender) of the related document. Furthermore, the strength of the identity of the organization is high (OrgIdStrength=#high). This matches with the “SenderIdStrength=#high” requirement of the “Service X”. Yet further, the “BizNetworkStrength=#high” property exceeds the the “SenderBizNetwrkStrength=#medium” requirement of the “Service X”.

Table 404 shows the properties of “Organization B” in relation to the “Service X”. The organization is the receiver (StakeholderType=#receiver) of the related document. The identity of the organization is deemed to be low (OrgIdStrength=#low). This may mean e.g. that the data of the organization has been entered into the system (e.g. 100 in FIG. 1) manually by a representative user of the organization, but the validity of the data has not been confirmed by anyone nor has it been used by any other organization. Because the service requirement data has “ReceiverIdStrength=#medium” requirement, service may be provided only, if the “OrgIdStrength” property is upgraded to at least “#medium”. The effort for this fix effort is estimated to have value 1.

Because the service requires certain level of trust on the identity of a user representing the sender (SenderRepUserIdTrust=#medium), the properties of User N in relation to the Service X need to be analysed by the computer system (e.g. 100 in FIG. 1). The results of this analysis are shown in table 405. The role of the “User N” in this analysis is the representative of the sender (UserRole=#senderRep). The strength of the user ID is assessed to be “low” (UserIdStrength=#low). This does not match with the “SenderRepUserIdTrust=#medium” requirement of the service. Therefore, an action (Fix effort=1) is required from the user to comply with the requirement. Finally, the user has obtained trust from the sender organization to represent the organization in the context of invoicing and financing (TrustedContext=#invoicing and TrustedContext=#financing). In a preferred embodiment, because of this trust the provider of the “Service X” 401 may communicate with the “User N” 405 in the context of the service e.g. when the service is provisioned for the “Organization A” 403.

In the above, an example about matching the service 401 with a transaction 402, organizations 403, 404 and user 405 is shown. To fix the deficiencies in the properties of the transaction, organizations and user requires a combined fix effort of value 6 (3+1+1+1). Now the “effort-adjusted” utility of the service for the target organization may be calculated to be e.g. 10/(6+1) where the 1 represents the effort of subscribing the service after the possible deficiencies in transaction, organization and user data have been fixed. If there are a plurality of candidate services identified for the target organization, the services may be prioritized for the target organization according to the effort-adjusted utility of the services.

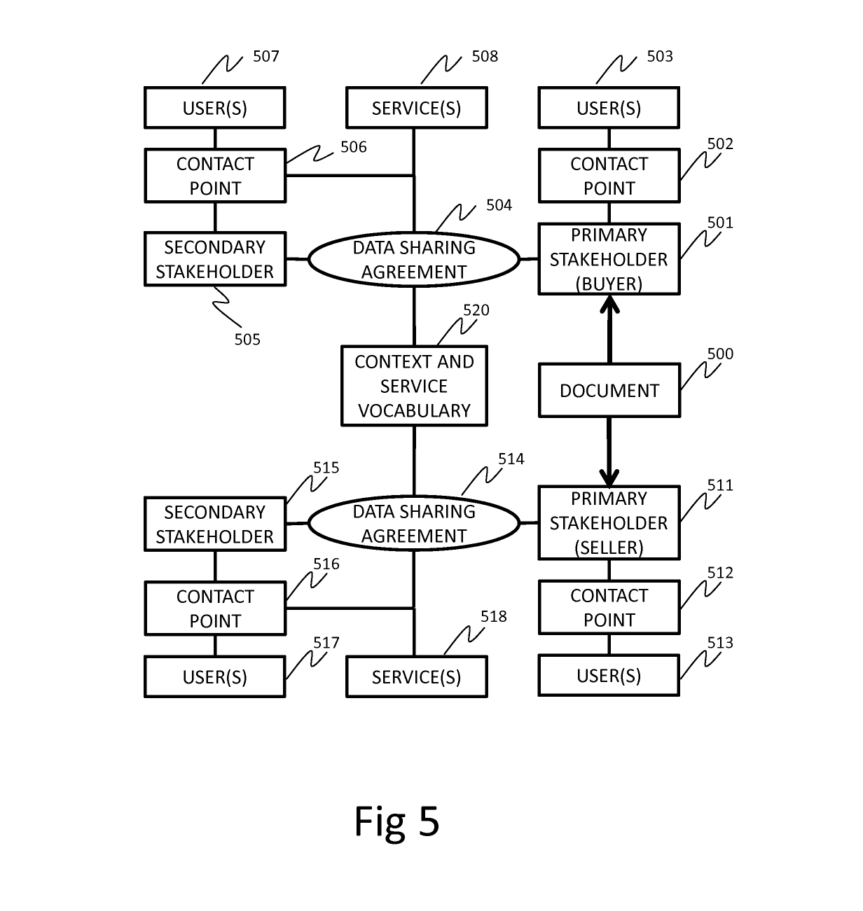

When the primary stakeholder has subscribed to a service for at least one transaction, the primary stakeholder needs to make the document (transaction) data available to the service provider who is now a secondary stakeholder of the document. In a preferred embodiment, this can be done by establishing a data sharing agreement with the service provider as shown in FIG. 5. The data sharing agreement is a mechanism with which the service providers may be associated with the primary stakeholders (e.g. sender and receiver) of a document as secondary stakeholders. In the following, an example about determining the stakeholders of a document, services relevant to the document as well as means for communication between users representing different stakeholders is provided.

When the data of a document 500 is written in the data storage 102 of platform 100, the stakeholders and users representing those stakeholders, who are allowed to access the document, need to be determined. First, the document content and/or meta data of the document are analyzed to identify primary stakeholders 501, 511 of the document. In a preferred embodiment, the primary stakeholders are the buyer and the seller of a business transaction document, e.g. an invoice or a purchaser order. The identification may be performed e.g. using the method described in FIG. 3a. Next, at least one contact point 502, 512 of each primary stakeholder is determined with which the document needs to be assigned. The assignment may be performed e.g. based on the data content and/or other properties of the document. For example, for buyer 501, there may be a contact point 502 for all incoming invoices. Similarly, for seller 511, there may be a contact point 511 for all outgoing invoices. For each contact point, at least one user 503, 513 is assigned. The assigned users have access to all the documents that are assigned with the contact point. In a preferred embodiment, a user who has been assigned to a contact point may delegate his access rights to another user.

Once the primary stakeholders of the document has been identified, the routing logic 104 of the platform 100, possibly together with application logic 103 analyses the currently existing and valid data sharing agreements 504, 514 of the primary stakeholders to identify organizations (legal entities) 505, 515 who are secondary stakeholders of the document 500. In a preferred embodiment, at least some of such secondary stakeholders provide services 508, 518 related to the document 500. The secondary stakeholder and the service for the data sharing agreement may have been identified e.g. using the method of FIG. 3b. The data sharing agreement is established, when the primary stakeholder subscribes to the potential service provided by the potential secondary stakeholder. The data sharing agreements 504, 514 specify the contact points 506, 516, from which the services 508, 518 may access the document 500. Each of the contact points 506, 516 may also be associated with at least one user 507, 517 who have access to the document(s) 500 of the contact point.

A service 508 related to a document typically produces service-specific data that needs to be communicated to at least one stakeholder of the document. In an embodiment, the stakeholder is the primary stakeholder 501 of the document. The service-specific data needs to be communicated to at least one contact point 502 from which at least one user 503 is able to access the data. In a preferred embodiment, the information about the contact point 502 to be used for the communication is defined in the data sharing agreement 504. The definition may be included in the agreement when the agreement has been established or the agreement may be amended later.

The provider 505 of the service 508 may also need to communicate with other stakeholders. However, the service 508 may not be able to automatically contact any other party but the primary stakeholder 501. For example, provider of a collaboration service, e.g. an invoice dispute resolution service, may need to establish communication not only with the buyer 501 but also with the seller 511 and a provider 515 of service 518, e.g. supplier financing service. To do this, the secondary stakeholder 505 may send an invitation to the buyer 501 who may forward it to the seller 511. The invitation may comprise information about the service from the context and service directory 520 which is a directory (service catalog) and vocabulary maintained by the platform 100. The seller 511 may accept the invitation by returning the invitation to the service provider 505 with contact point information 512. The seller 511 may also forward the invitation to the supplier financing service provider 515 who may accept it in a similar manner, i.e. by returning the invitation with contact point information 516. The contact point information of the data sharing agreement 504 may now be amended with the new contact points.

The invitation to be forwarded from primary stakeholder 501 to a second primary stakeholder 511 may be a re-usable one. For example, it may be automatically sent to a different second primary stakeholder 511, whenever the service 508 is activated in conjunction with a new document 500 that has a new second primary stakeholder 511, e.g. a seller.

The information of the data sharing agreements, including activities and communication between the stakeholders, may be utilized e.g. by the service matcher 130 when assessing e.g. the trust levels of the stakeholders and users. Generally, the more there are connections and activities, especially bi-directional data exchange activities, between organizations and/or users, the better the entities may be considered to be networked with each other.

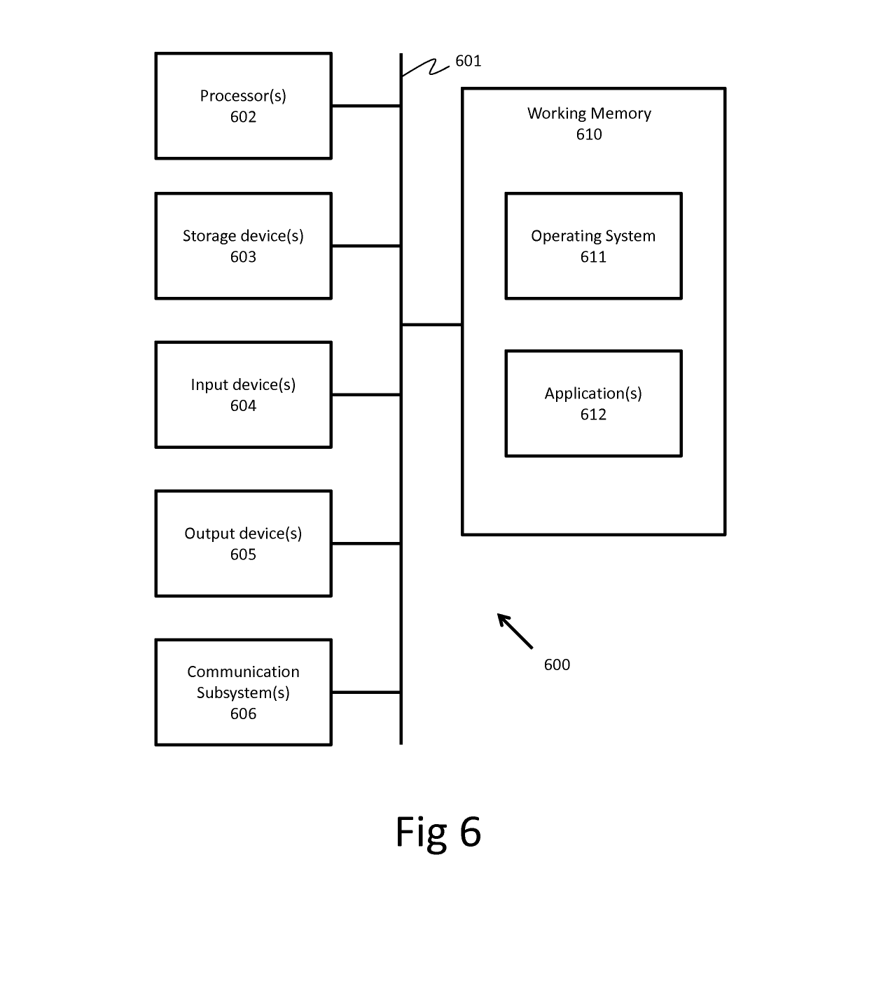

FIG. 6 shows a schematic illustration of one embodiment of a computer system that can perform the methods of the described embodiment. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 601 (or may otherwise be in communication, as appropriate). The hardware elements can include one or more processors 602, communication subsystems 603, one or more input devices 604, which can include without limitation a mouse, a keyboard and/or the like; and one or more output devices 605, which can include without limitation a display device, a printer and/or the like. The computer system 600 may further include (and/or be in communication with) one or more storage devices 603. The computer system 600 also can comprise software elements, shown as being located within the working memory 610, including an operating system 611 and/or other code, such as one or more application programs 612, which may comprise computer programs of the described embodiments, and/or may be designed to implement methods of the described embodiments of a computer-method of the embodiments as described herein.

At least some embodiments include a program storage device readable by a machine, tangibly embodying a program of instructions executable by the machine to perform a computer-executable method of an embodiment of the present invention.

Although specific embodiments have been described and illustrated, the embodiments are not to be limited to the specific forms or arrangements of parts so described and illustrated.

1. A computer-implemented method for assigning a service to a document and to a stakeholder in a computer executable service platform comprising:
a content analysis service,
an identity evaluation service, and
a service allocation service,
wherein the document has a sender, a receiver and content interpretable as structured content, wherein the method contains computer executable steps:
the identity evaluation service evaluating at least one attribute regarding the identity of at least one of the following:
a stakeholder of the document having a role of a sender or a receiver, and
a user representing the stakeholder and having access to the document,
the content analysis service resolving at least one attribute value from the document, and
the service allocation service assigning at least one service to the document based on a match between the requirements of the service and at least one of the following:
the results of the execution of the identity evaluation service, and
the results of the execution of the content analysis service.

2. A method of claim 1, wherein the method comprises the step of calculating and storing information comprising estimate of the utility of the service to the stakeholder.

3. A method of claim 1, wherein the method comprises step for storing information comprising estimation about an effort required to remedy a deficiency in at least one of the following:
an attribute of the document
an attribute of the stakeholder
an attribute of a user related to the stakeholder.

4. A method of claim 1, wherein the method comprises the content analysis service identifying at least one attribute whose value is missing from the document required to use the service.

5. A method of claim 4, wherein the method comprises the service allocation service to prepare a computer executable instruction adapted to remedy the missing attribute value of the document.

6. A method of claim 1, wherein the method comprises the identity analysis service identifying at least one attribute of the stakeholder or the user that has a missing or insufficient value to use the service.

7. A method of claim 6, wherein the method comprises the service allocation service to prepare a computer executable instruction adapted to remedy the missing or insufficient attribute value of the stakeholder or user.

8. A method according to claim 1, wherein the method further comprises the step of the stakeholder to subscribe the assigned service.

9. A system for assigning a service to a document and to a stakeholder in a computer executable service platform comprising:
a content analysis service,
an identity evaluation service, and
a service allocation service,
wherein the document has a sender, a receiver and content interpretable as structured content, the system comprising one or more processors and memory having instructions stored thereon, wherein the instructions, if executed by the one or more processors, cause the system to perform operations comprising:
the identity evaluation service evaluating at least one attribute regarding the identity of at least one of the following:
a stakeholder of the document having a role of a sender or a receiver, and
a user having access to the document,
the content analysis service resolving at least one attribute value from the document, and
the service allocation service assigning at least one service to the document based on a match between the requirements of the service and at least one of the following:
the results of the execution of the identity evaluation service, and
the results of the execution of the content analysis service.

10. A computer-program product for assigning a service to a document and to a stakeholder in a computer executable service platform comprising:
a content analysis service,
an identity evaluation service, and
a service allocation service,
wherein the document has a sender, a receiver and content interpretable as structured content, the program having instructions, the instructions wherein, when executed by one or more processors, cause the processors to perform operations comprising:
the identity evaluation service evaluating at least one attribute regarding the identity of at least one of the following:
a stakeholder of the document having a role of a sender or a receiver, and
a user representing the stakeholder and having access to the document,
the content analysis service resolving at least one attribute value from the document, and
the service allocation service assigning at least one service to the document based on a match between the requirements of the service and at least one of the following:
the results of the execution of the identity evaluation service, and
the results of the execution of the content analysis service.
